(19) United States
(12) Patent Application Publication
(10) Pub. No.: US 2008/0191665 A1
(43) Pub. Date: Aug. 14, 2008

(54) CHARGING CIRCUIT

(75) Inventors: Kung Shao-Tsu, Taipei City (TW); Chuang Chih Tarng, Taipei City (TW); Chen Chia Chang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/769,717

(22) Filed: Jun. 28, 2007

(30) Foreign Application Priority Data
Feb. 13, 2007 (TW) 96105239

(51) Int. Cl. H02J 7/00

(52) U.S. Cl. 320/141

(57) ABSTRACT

A charging circuit is provided. In the present invention, a capacitor and a resistor are added to the circuit near the charging switch. Due to the electrical charges stored in the capacitor, the rising and decreasing rate of the battery voltage of a rechargeable battery can be diminished during the pulse charge stage. Thereby, the probability of battery cell damage is reduced, and the safety of using the rechargeable battery is guaranteed.

### CROSS-REFERENCE TO RELATED APPLICATION

This application claims the priority benefit of Taiwan application serial no. 96105239, filed Feb. 13, 2007. All disclosure of the Taiwan application is incorporated herein by reference.

### BACKGROUND OF THE INVENTION

1. Field of the Invention

The present invention relates to a charging circuit. More particularly, the present invention relates to a charging circuit for a pulse charging method.

2. Description of Related Art

For a conventional charging method, generally, a rechargeable battery of small charge capacity is rapidly charged by means of pulse charge. FIG. 1 is a circuit diagram of a conventional charging system. Referring to FIG. 1, in the charging system 100, the charging power source 120 provides a charging voltage and a charging current to the charging circuit 110, and the charge controller 113 in the charging circuit 110 controls the ON/OFF of the charging switch 111, thus determining whether or not to charge the rechargeable battery 130. The sensing element 115 is coupled between the charge controller 113 and the rechargeable battery 130, for sensing the battery voltage of the rechargeable battery 130. Further, when the voltage of the rechargeable battery 130 is low, the charging system 100 charges by means of constant current. When the voltage of the rechargeable battery 130 exceeds a specific upper limit value (Vcoff), the charging system 100 continues charging by means of pulse charge. When the voltage of the rechargeable battery 130 exceeds the upper limit value, the charge controller 113 turns off the charging switch 111, so as to stop providing the charging power source to the rechargeable battery 130 until the battery voltage of the rechargeable battery 130 drops to a lower limit value (Vcon). At this time, the charge controller 113 turns on the charging switch 111 for providing the charging power source to the rechargeable battery 130 again.

However, though the pulse charging method is advantageous in fast charging, the safety of using the rechargeable battery is affected to some extent. FIG. 2 is a curve diagram of variation of the charging current and voltage in the conventional pulse charge. As shown in FIG. 2, when the pulse charge is performed on the rechargeable battery, and when the state of the charging switch is changed from OFF to ON, or from ON to OFF, the rising and decreasing rate (dV/dt) of the battery voltage is sharp. The above circumstance may easily result in that the accumulation or dissociation of chemicals inside the rechargeable battery becomes unstable, thus causing battery cell damage. As such, the rechargeable battery may even be burnt to cause great disaster.

### SUMMARY OF THE INVENTION

In view of the above, a charging circuit is provided to diminish the rising and decreasing rate of the battery voltage during the pulse charge stage, so that the safety of using the rechargeable battery is guaranteed.

A charging circuit including a charging switch, a capacitor, a resistor, and a charge controller is provided. The charging switch includes a first source/drain, a second source/drain, and a gate. The second source/drain is coupled to a charging power source. A first end of the capacitor is coupled to the first source/drain of the charging switch. A first end of the resistor is coupled to the gate of the charging switch, and is connected in series to a second end of the capacitor. The charge controller is coupled to a second end of the resistor and the charging power source for controlling the ON/OFF of the charging switch, so as to provide the charging power source to the battery.

The charging circuit according to an embodiment of the present invention further includes a sensing element coupled to the charge controller and the battery, for sensing the battery voltage of the battery.

The charging circuit according to an embodiment of the present invention, wherein the charge controller turns on the charging switch to provide the charging power source to the battery if the charge controller determines that the battery voltage is lower than a specific voltage by means of the sensing element.

The charging circuit according to an embodiment of the present invention, wherein the charge controller turns off the charging switch to stop providing the charging power source to the battery if the charge controller determines that the battery voltage is greater than or equal to a specific voltage by means of the sensing element.

The charging circuit according to an embodiment of the present invention, the resistor comprises an SMD resistor with a specification of 0402 or 0603.

In the charging circuit according to an embodiment of the present invention, the charging switch comprises a field-effect transistor (FET) switch.

In the present invention, a capacitor and a resistor are added to the circuit near the charging switch. Attributable to the electrical charges are stored in the capacitor, the rising and decreasing rate of the battery voltage can be diminished during the pulse charge stage. Thereby, the probability of battery cell damage is reduced, and the safety of using the rechargeable battery is guaranteed.

In order to make the aforementioned and other objectives, features, and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional charging system.

FIG. 2 is a curve diagram of variation of the charging current and voltage in the conventional pulse charge.

FIG. 3 is a circuit diagram of a charging system according to an embodiment of the present invention.

FIG. 4 is a curve diagram of variation of the charging current and voltage according to an embodiment of the present invention.

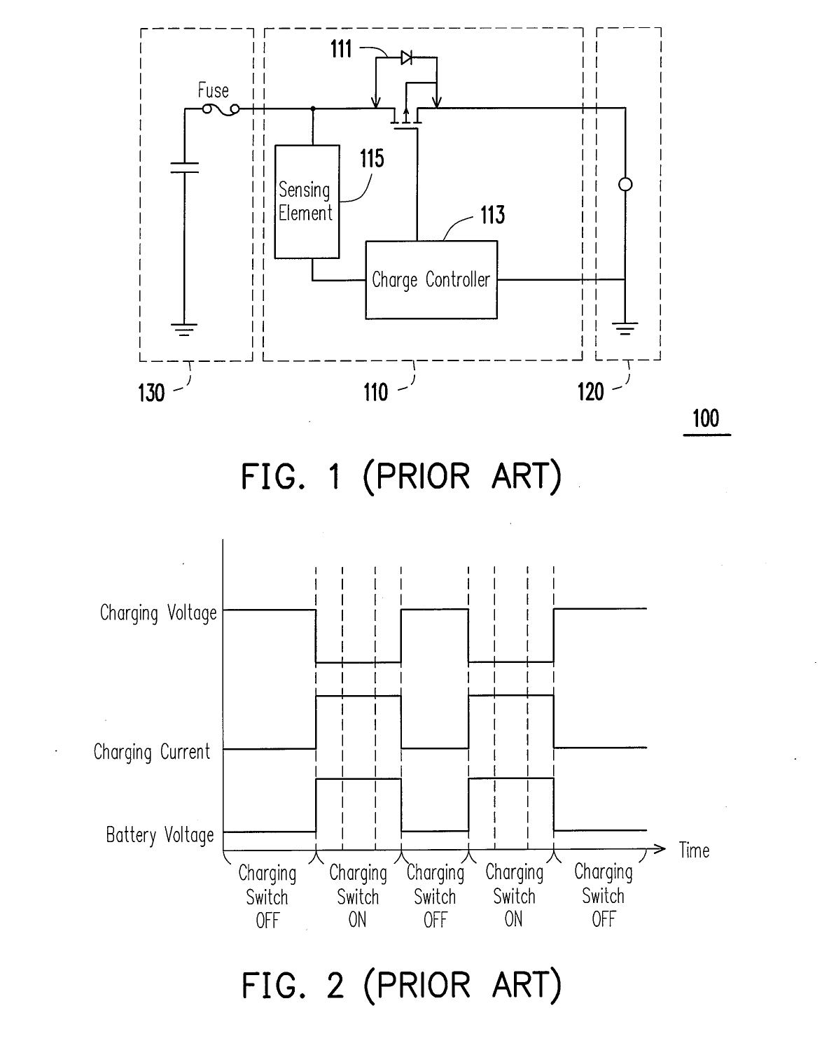

### DESCRIPTION OF EMBODIMENTS

Generally speaking, when the rising or decreasing rate of the battery voltage of a rechargeable battery is large, the changes of the chemicals inside the battery are quickened, which even worse may cause battery explosion. In order to avoid the above circumstance, the present invention further provides a charging circuit for diminishing the change rate of the battery voltage during the pulse charge stage. To make the content of the present invention more apparent, embodiments are given below for practical implementation of the present invention.

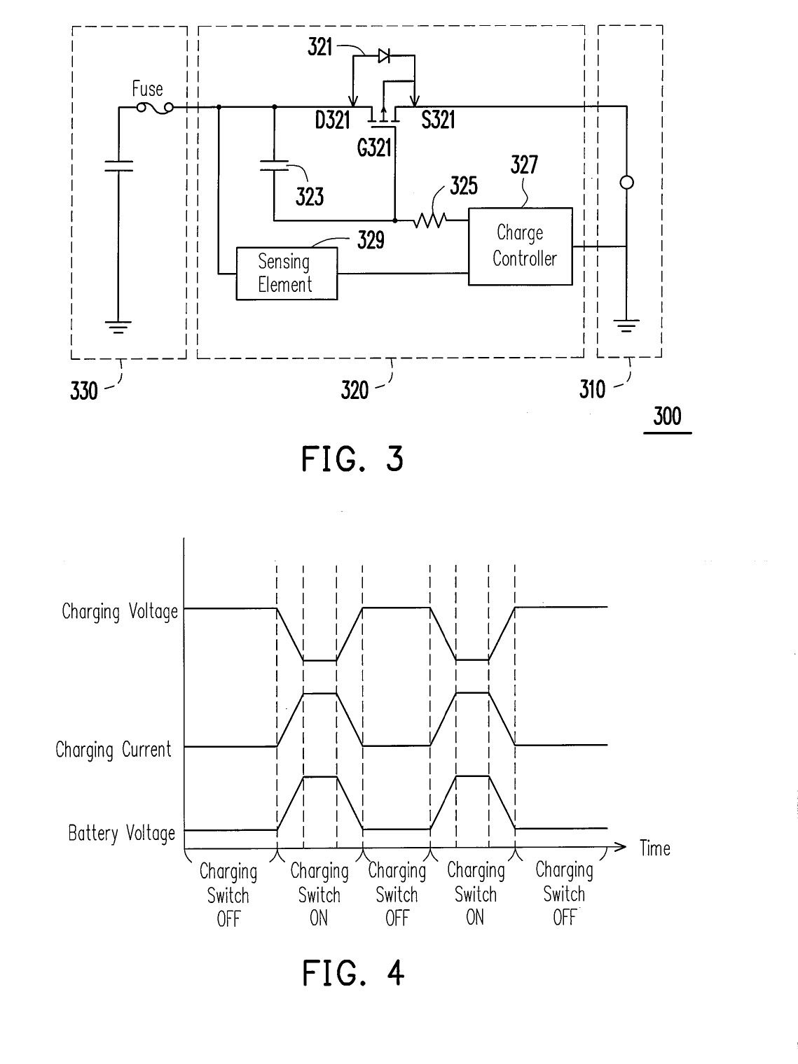

FIG. 3 is a circuit diagram of a charging system according to an embodiment of the present invention. Referring to FIG. 3, this embodiment illustrates in the charging system 300 how a charging circuit 320 utilizes the charging voltage and charging current provided by a charging power source 310 to charge a rechargeable battery 330.

The charging circuit 320 includes a charging switch 321, a capacitor 323, a resistor 325, a charge controller 327, and a sensing element 329. The charging switch 321 is, for example, a field-effect transistor (FET) switch, which has a source S321, a drain D321, and a gate G321. In this embodiment, the source S321 of the charging switch 321 is coupled to the charging power source 310.

A first end of the capacitor 323 is coupled to the drain D321 of the charging switch 321. A first end of the resistor 325 is coupled to the gate G321 of the charging switch 321, and is connected in series to a second end of the capacitor 323. In this embodiment, the resistor 325 is, for example, an SMD resistor, with a specification of 0402 or 0603, which is not limited herein.

The charge controller 327 is coupled between a second end of the resistor 325 and the charging power source 310, for controlling the ON/OFF of the charging switch 321, so as to provide the charging power source 310 to the rechargeable battery 330. The sensing element 329 is coupled between the charge controller 327 and the rechargeable battery 330, for sensing the battery voltage of the rechargeable battery 330.

In this embodiment, before the charging power source 310 is provided for charging, a general AC power source is converted into a DC power source by, for example, a rectiformer (not shown). When the charging system 300 enters the pulse charge stage, if the charge controller 327 determines that the current battery voltage of the rechargeable battery 330 is greater than or equal to a specific upper limit voltage through the sensing element 329, the charge controller 327 controls the charging switch 321 to turn off, so as to stop outputting the charging voltage and charging current provided by the charging power source 310 to the rechargeable battery 330. As the capacitor 323 stores a part of electrical charges, even if the charging switch 321 is turned off and the charging is stopped, the electrical charges previously stored in the capacitor 323 when the charging switch 321 is turned on can diminish the decreasing rate of the battery voltage of the rechargeable battery 330. That is, the electrical charges stored in the capacitor 323 can diminish the decreasing rate of the battery voltage, thus guaranteeing the safety of using the rechargeable battery 330.

After a while, when the charge controller 327 determines that the battery voltage of the rechargeable battery 330 is lower than a specific lower limit voltage by the use of the sensing element 329, the charge controller 327 controls the charging switch 321 to turn on, so as to output the charging voltage and charging current provided by the charging power source 310 to the rechargeable battery 330. When the charging switch 321 is turned on, a part of the electrical charges passing through the charging switch 321 are stored in the capacitor 323, thus diminishing the rising rate of the battery voltage of the rechargeable battery 330. As the rising rate of the battery voltage is diminished, the safety of using the rechargeable battery 330 is guaranteed.

FIG. 4 is a curve diagram of variation of the charging current and voltage according to an embodiment of the present invention. It can be found by comparing FIG. 2 and FIG. 4 that when the charging circuit of the present invention performs pulse charge on the rechargeable battery, no matter the state of the charging switch is changed from OFF to ON, or from ON to OFF, the rising and decreasing curves of the battery voltage of the rechargeable battery are diminished. As such, the rising and decreasing rate of the battery voltage can be reduced, thus guaranteeing the safety of using the rechargeable battery.

In view of the above, the charging circuit of the present invention has at least the following advantages.

1. The rising and decreasing rate of the battery voltage of a rechargeable battery can be diminished during the pulse charge stage. Thereby, the probability of battery cell damage is reduced, and the safety of using the rechargeable battery is guaranteed.

2. The change rate of the battery voltage can be diminished by merely adding a capacitor and a resistor in a general charging circuit, thus achieving the purpose of reducing the hardware cost without increasing extra hardware.

3. The safety of using the rechargeable battery is enhanced, and meanwhile the advantage of fast charge of the pulse charge is guaranteed.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A charging circuit, comprising:
a charging switch, comprising a first source/drain, a second source/drain, and a gate, wherein the second source/drain is coupled to a charging power source;
a capacitor, with a first end coupled to the first source/drain of the charging switch;
a resistor, with a first end coupled to the gate of the charging switch, and connected in series to a second end of the capacitor; and
a charge controller, coupled to a second end of the resistor and the charging power source, for controlling ON/OFF of the charging switch, so as to provide the charging power source to a battery.

2. The charging circuit as claimed in claim 1, further comprising:
a sensing element, coupled to the charge controller and the battery, for sensing a battery voltage of the battery.

3. The charging circuit as claimed in claim 2, wherein the charge controller turns on the charging switch to provide the charging power source to the battery if the charge controller determines that the battery voltage is lower than a specific voltage by the use of the sensing element.

4. The charging circuit as claimed in claim 2, wherein the charge controller turns off the charging switch to stop providing the charging power source to the battery if the charge controller determines that the battery voltage is greater than or equal to a specific voltage by the use of the sensing element.

5. The charging circuit as claimed in claim 1, wherein the resistor comprises an SMD resistor.

6. The charging circuit as claimed in claim 5, wherein a specification of the SMD resistor is 0402.

7. The charging circuit as claimed in claim 5, wherein a specification of the SMD resistor is 0603.

8. The charging circuit as claimed in claim 1, wherein the charging switch comprises a field-effect transistor (FET) switch.
